(19) United States
(12) Patent Application Publication
(10) Pub. No.: US 2015/0095431 A1
(43) Pub. Date: Apr. 2, 2015

(54) VIEW OF INFORMATION RELATING TO A RELATIONSHIP BETWEEN ENTITIES

(71) Applicant: Microsoft Corporation, Redmond, WA (US)

(72) Inventors: Samuel Koppes, Bothell, WA (US); Neal Myerson, Seattle, WA (US); Srikrishna Gali, Redmond, WA (US); Paul Lo, Mill Creek, WA (US); Joseph Masterson, Renton, WA (US)

(73) Assignee: Microsoft Corporation, Redmond, WA (US)

(21) Appl. No.: 14/042,564

(22) Filed: Sep. 30, 2013

(51) Int. Cl. H04L 29/06

(52) U.S. Cl. CPC H04L 65/403
USPC 709/206; 709/204

(57) ABSTRACT

A relationship view system generates a relationship view of information for a relationship between a user and another person for display to the user. The relationship view system identifies information relating to the person. For each of a plurality of information types, the relationship view system identifies items of that information type that are related to both the user and the person. The relationship view system then generates a display page for displaying information relating to the identified items of each information type. The generated display page thus displays information related to both the user and the person for multiple information types simultaneously.

### BACKGROUND

Computer systems typically display information to a user that is specific to a type of information, such as conversations (e.g., electronic mail messages and instant messages), calendar events (e.g., meetings), documents, contact information, and so on. For example, an electronic mail system typically displays a window that lists electronic mail messages ordered by time received by default. Electronic mail systems, however, typically allow the user to change the ordering of electronic mail messages. Thus, a user interested in reviewing electronic mail messages from a particular sender may sort the electronic mail messages based on the “from” field. In another example, calendar systems typically display a window that lists meetings scheduled for the current day ordered by time by default. Calendar systems may also allow the user to search for meetings that are related to a certain topic or organized by a certain person.

Some computer systems will display a window with summary information for multiple information types. For example, one computer system provides a window through which a user can view meeting information, task information, and electronic mail information side-by-side. Such summary information may simply be a summary of the default information that that would be displayed in the window for information of that type. For example, the summary information for electronic mail messages may include a count of the unread messages in the inbox, a count of the unsent messages in the outbox, and so.

These computer systems can be used to access information about a certain contact to view all of the information shared with that contact. For example, a user would use an electronic mail system to identify messages exchanged with that contact, a calendar system to identify meetings attended by both the user and a contact, a document management system to identify documents shared between the user and the contact, and so on.

### SUMMARY

A relationship view system generates a relationship view of information for a relationship between a user and another person for display to the user. The relationship view system identifies information relating to the person. For each of a plurality of information types, the relationship view system identifies items of that information type that are related to both the user and the person. The relationship view system then generates a display page for displaying information that relates to the identified items of each information type. The relationship view system generates a display page for displaying information that is related to both the user and the person for multiple information types simultaneously.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

### DESCRIPTION OF THE DRAWINGS

FIG. 1 illustrates a display page displaying a relationship view of information with a person as a focus in some embodiments.

FIG. 2 illustrates a display page displaying a relationship view of information with a meeting as a focus in some embodiments.

FIG. 3 illustrates a display page displaying a relationship view of information with a person and a meeting as the focuses in some embodiments.

FIG. 4 illustrates a display page displaying a hover card containing a condensed relationship view of information with a person as a focus in some embodiments.

FIG. 5 is a block diagram that illustrates components of the relationship view system in some embodiments.

FIG. 6 is a flow diagram that illustrates the processing of a generate relationship window component in some embodiments.

FIG. 7 is a flow diagram that illustrates the processing of a populate persons panel component in some embodiments.

FIG. 8 is a flow diagram that illustrates the processing of a populate conversations panel component in some embodiments.

FIG. 9 is a flow diagram that illustrates the processing of a generate conversations list component in some embodiments.

FIG. 10 is a flow diagram that illustrates the processing of a populate meetings panel component in some embodiments.

### DETAILED DESCRIPTION

A method and system for providing a relationship view of information that relates to both a user and another person is provided. In some embodiments, a relationship view system receives from a user an indication of the person who is the focus of the relationship of interest. For example, if the user is Mark, then Mark selects John as the focus of the relationship. The relationship view system then identifies items of information for multiple information types that relate to both the user and the person. For example, the relationship view system may interface with an electronic mail system to identify all the messages exchanged between the user and the person. The relationship view system may also interface with a calendar system to identify, for example, all the meetings that include both the user and the person as attendees. The relationship view system may also identify contact information for the person. The relationship view system then provides the identified information for the different information types (e.g., electronic mail messages, meetings, contact information, documents, voice mails, instant messages, text messages, posts, blogs, and tweets) for simultaneous display to the user. When the information is displayed to the user, the user will quickly receive the information in one display that highlights the relationship between the user and the person who is the focus of the relationship with the user.

In some embodiments, the relationship view system provides a relationship view of information for relationships between the user and various types of entities as the focus of the relationship. For example, the relationship view system may allow an entity that is the focus of the relationship to be a document. For example, the user may have the relationship with the document because the user authored the document. The relationship view system may interface with an electronic mail system to identify messages relating to the user (e.g., sent or received by the user) that relate to the document (e.g., contain a reference to that document or have the same subject as the document). The relationship view system may interface with a calendar system to identify meetings that relate to the document (e.g., listed as an attachment to a meeting invite). The relationship view system may also interface with a contact system to identify contact information for persons related to the document. A person who is related to a document may be a co-author of the document, an attendee of a meeting related to the document, a recipient of an electronic mail message related to the document, and so on. The entities that are the focus of a relationship may include persons, documents, conversations, messages, organizations, calendar events, and other things that a user may have a relationship with.

In some embodiments, the relationship view system may provide relationship views for relationships that have multiple focuses. For example, a user may have a relationship with a person and a document. In such a case, the relationship view system identifies information that relates to the user, the person, and the document. For example, the relationship view system may interface with an electronic mail system to identify all messages with the user and the person as recipients and that relate to the document. In such a case, if a message relates to the user and the document but the person is not a recipient, the relationship view system would not consider that message to be related to the relationship. The relationship view system may also allow the focus to be a collection entity of one or more persons with each person being a member of the collection entity. A collection entity may be a division of a company or a company, an organization, a school, a list of persons, and so on. When the focus is a collection entity, the relationship view system may identify information that relates to the user and any one of the members of the collection entity. For example, the relationship view system may identify all messages sent between the user and any member of the collection entity.

In some embodiments, the relationship view system displays the information relating to a relationship in a window that has a separate panel for each information type. For example, if the focus of the relationship is a person, then one panel may contain contact information for that person, another panel may list electronic mail messages with the user and that person as participants (e.g., the recipient or the sender), another panel may list meetings that include both the user and that person as attendees, and so on. The relationship view system may also display information about multiple information types in a hover card as a user “hovers over” a certain entity. For example, a picture of the caller may be displayed when a phone call is received. When the user hovers over the picture, the relationship view system may display a hover card that identifies any electronic mail messages relating to the user and that person, identifies any meetings relating to both the user and that person, and so on. If the user does not have a relationship with the person (e.g., no related messages, meetings, or calendar events), then the hover card may contain general contact information about the person such as contact information, title, and so on.

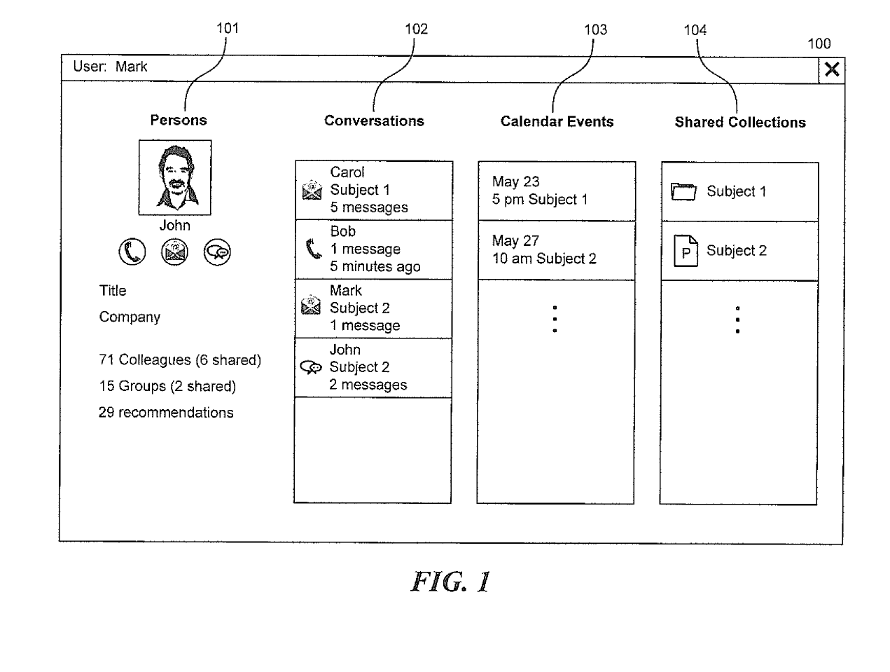

FIG. 1 illustrates a display page displaying a relationship view of information with a person as a focus in some embodiments. A display page 100 includes a persons panel 101, a conversations panel 102, a calendar events panel 103, and a shared collections panel 104. The persons panel 101 includes contact information for the relationship between the user, Mark, and the person, John, who is the focus of the relationship. The persons panel 101 displays a picture of the person, icons for communicating with the person, the title and company the person works for, and indications of the number of colleagues, groups, and recommendations related to that person. The conversations panel 102 includes an indication of electronic mail conversations, telephone conversations, voice mail conversations, and instant message conversations that include both Mark and John. For example, the indication of the first conversation identifies that Carol initiated a conversation that relates to Subject1 and that includes five messages. Both Mark and John may be related to that conversation because they received or sent a message that is part of the conversation. The calendar events panel 103 includes an indication of the calendar events that relate both to Mark and John. The first calendar event indicates the occurrence of a meeting scheduled for May 23 at 5 PM that relates to Subject1. Both Mark and John may be related to that meeting because they were both asked to attend the meeting or because one of them is an organizer and the other was asked to attend. The shared collections panel 104 identifies the folders and documents that are shared by Mark and John either individually or through groups to which they belong. The first shared collection includes a folder of documents relating to Subject1. Although the panels are shown arranged vertically, they may also be arranged horizontally. More generally, the related information may be displayed using a variety of organization techniques arranged by time, subject, and so forth.

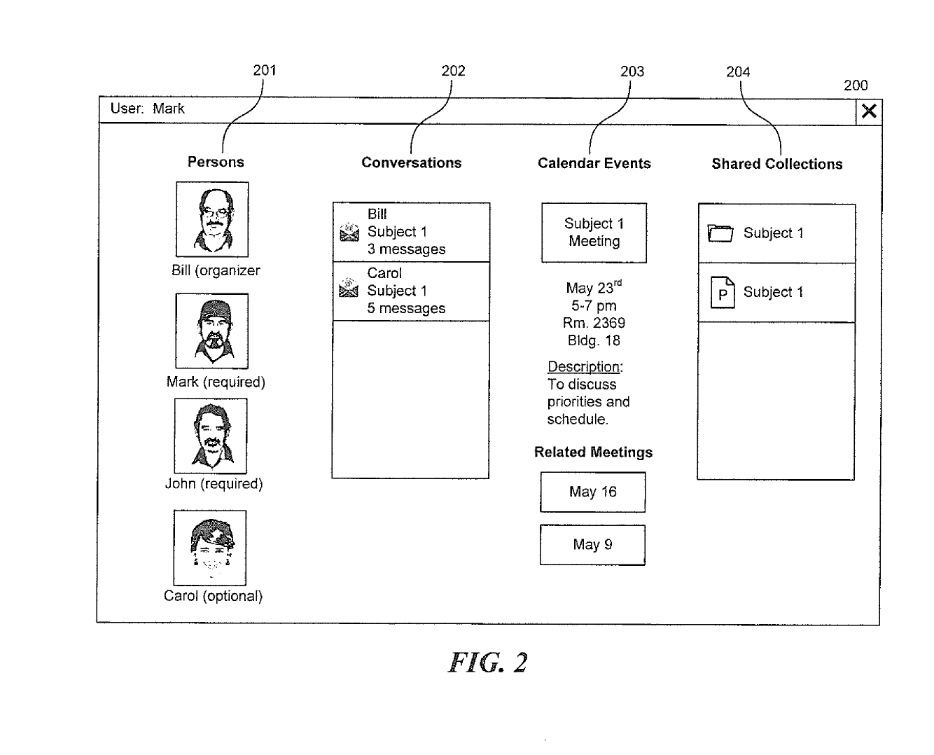

FIG. 2 illustrates a display page displaying a relationship view of information with a meeting as a focus in some embodiments. A display page 200 includes a persons panel 201, a conversations panel 202, a calendar events panel 203, and a shared collections panel 204. The calendar events panel 203 contains calendar information relating to the meeting that is the focus of the relationship. That calendar information includes the time and place of the meeting, a description of the meeting, and an indication of related meetings. The display page 200 may have been displayed when a user selected the indication of the meeting of May 23 from the calendar events panel 103. The persons panel 201 identifies the persons related to the meeting. The conversations panel 202 identifies the conversations related to the meeting. The shared collections panel 204 identifies the documents that are related to the meeting. The conversations panel 202 includes an indication of an electronic mail conversation initiated by Bill that relates to the meeting. The conversations panel 102 has no corresponding indication because John was not a participant in that conversation.

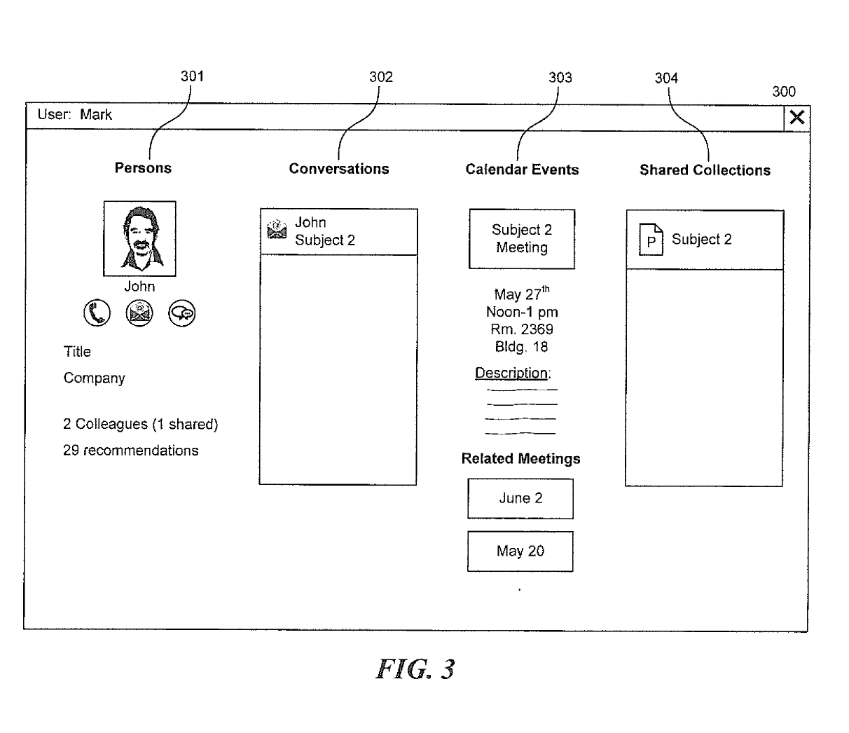

FIG. 3 illustrates a display page displaying a relationship view of information with a person and a meeting as the focuses in some embodiments. A display page 300 includes a persons panel 301, a conversations panel 302, a calendar events panel 303, and a shared collections panel 304. The person of focus is John and the meeting of focus is the meeting on May 27 relating to Subject2. The persons panel 301 identifies John as the focus of the relationship and includes information similar to the persons panel 101 except that the totals for other indications, such as colleagues, may be adjusted to identify only those colleagues who will be attending the meeting that is also a focus. The calendar events panel 303 identifies the meeting that is the focus of the relationship and any related meetings. The conversations panel 302 identifies the conversations taking place between Mark and John that relate to the meeting that is the focus of the relationship. The shared collections panel 304 identifies any documents that relate to the meeting and both Mark and John.

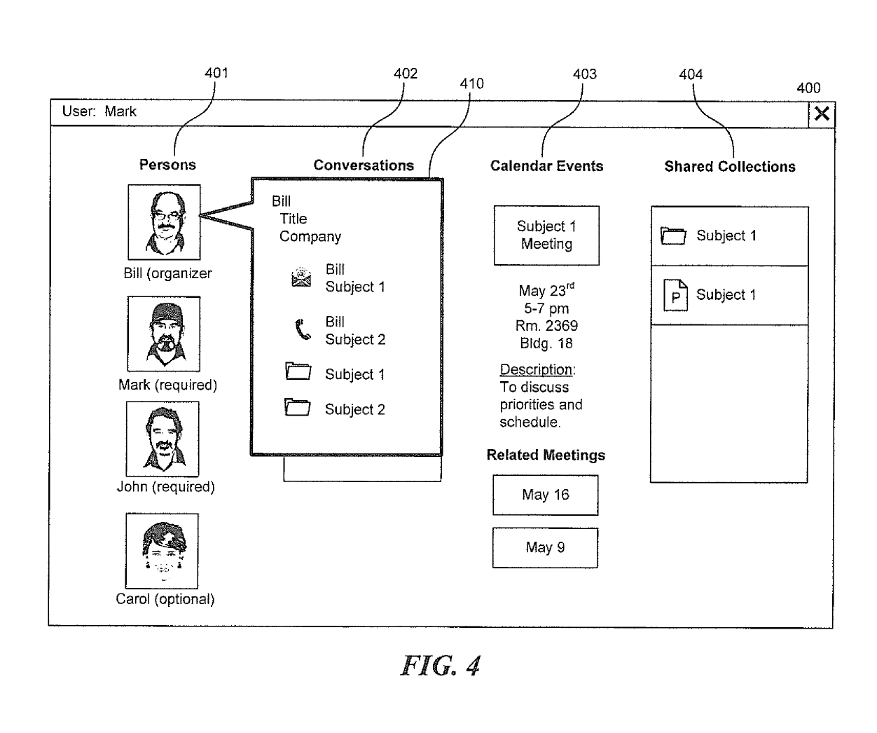

FIG. 4 illustrates a display page displaying a hover card containing a condensed relationship view of information with a person as a focus in some embodiments. A display page 400 includes a persons panel 401, a conversations panel 402, a calendar events panel 403, and a collection panel 404 as illustrated in FIG. 2. When the user hovers over the image of Bill, the relationship view system displays a hover card 410. The hover card 410 includes information relating to the relationship between Mark and Bill. The information may be a condensed form of the information that would be displayed in the separate panels of FIG. 1 with Bill as the focus of the relationship.

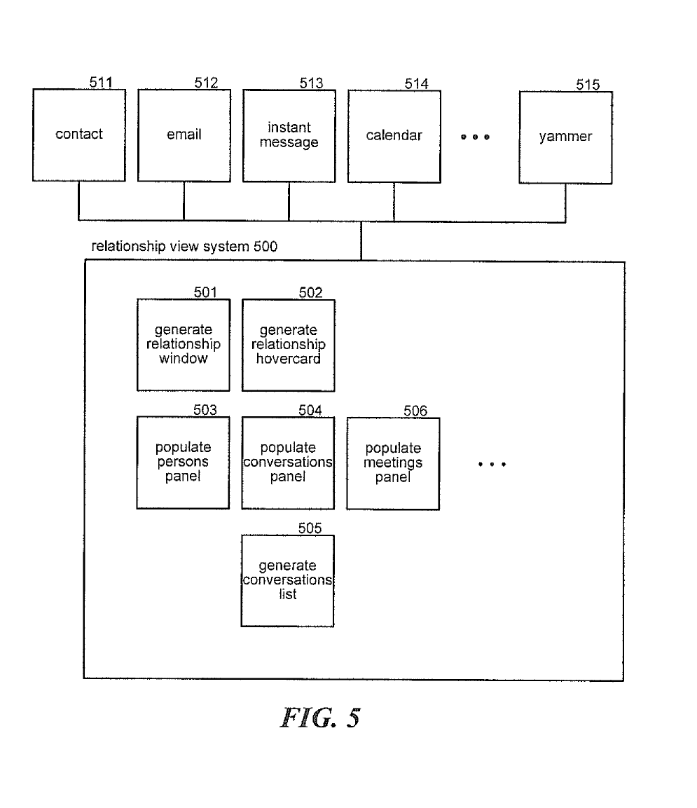

FIG. 5 is a block diagram that illustrates components of the relationship view system in some embodiments. The relationship view system 500 may interface with various information sources (e.g., external systems) such as a contact system 511, an electronic mail system 512, an instant message system 513, a calendar system 514, and a social network system (e.g., YAMMER) 515. The relationship view system includes a generate relationship window component 501, a generate relationship hover card component 502, a populate persons panel component 503, a populate conversations panel 504, a generate conversations list component 505, and a populate meetings panel component 506. The generate relationship window component 501 controls the generation of a display page of information relating to a relationship with a separate panel for each information type. The populate persons panel component 503 populates the persons panel based on the focus of the relationship. The populate conversations component panel 504 populates the conversations panel based on the focus of the relationship by invoking the generate conversations list component 505. The generate conversations list component 505 generates a conversation list for each type of conversation. The populate meetings panel component 506 populates the meeting panel with information relating to meetings that are related to the focus of the relationship. The generate relationship hover card component 502 generates a hover card containing a condensed version of the information displayed in a relationship window.

The computing devices on which the relationship view system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a propagated signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the prioritization system. The data transmission media is media for transmitting data using propagated signals or carrier waves (e.g., electromagnetism) via a wire or wireless connection.

The relationship view system may be described in the general context of computer-executable instructions, such as program modules and components, executed by one or more computers, processors, or other devices. Generally, program modules or components include routines, programs, objects, data structures, and so on, that perform particular tasks or implement particular data types. Typically, the functionality of the program modules may be combined or distributed as desired in various embodiments. For example, the components of the relationship view system 500 may be implemented on a web server that serves web pages containing the information of display pages 200, 300, 400, and 500. Some or all of the components of the relationship view system may be implemented on a computer system of a user or an enterprise. Aspects of the relationship view system may be implemented in hardware using, for example, an application-specific integrated circuit (“ASIC”).

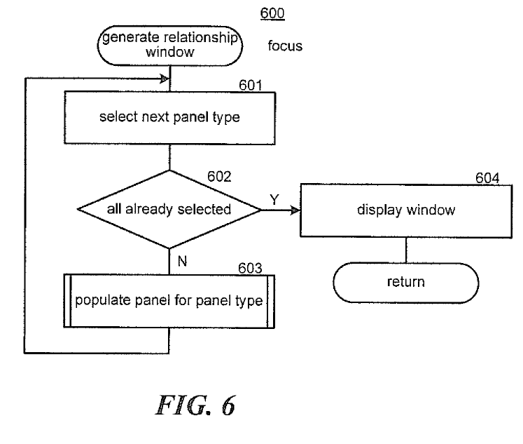

FIG. 6 is a flow diagram that illustrates the processing of a generate relationship window component in some embodiments. The generate relationship window component 600 receives an indication of the focus of the relationship for the user and populates each of the panels of the window. In block 601, the component selects the next panel type, such as a person or conversation. In decision block 602, if all of the panel types have already been selected, then the component continues at block 604, else the component continues at block 603. In block 603, the component invokes a populate panel component that is specific for the selected panel type in order to populate the panel of the window, and then loops to block 601 to select the next panel type.

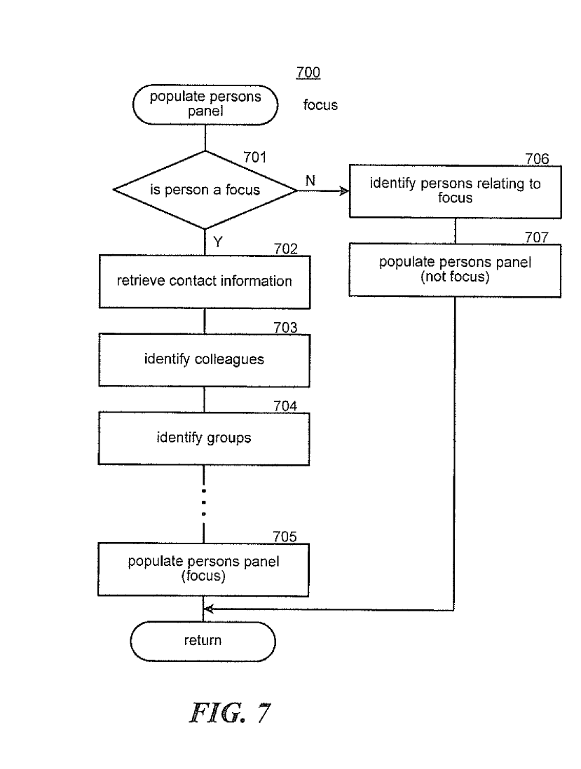

FIG. 7 is a flow diagram that illustrates the processing of a populate persons panel component in some embodiments. The populate persons panel 700 is passed an indication of the focus of the relationship with the user and populates the panel based on whether a person is a focus of the relationship. In decision block 701, if a person is a focus of the relationship, then the component continues at block 702, else the component continues at block 706. In block 702, the component retrieves contact information for the person who is a focus of the relationship. In block 703, the component identifies the colleagues of the person who is the focus of the relationship. In block 704, the component identifies the groups of which the person who is a focus of the relationship is a member. In block 705, the component populates the persons panel based on a person being the focus (e.g., the persons panel 101) and then returns. In block 706, the component identifies the persons that are related to the focus. In block 707, the component populates the persons panel based on a person not being a focus (e.g., the persons panel 201) and then returns.

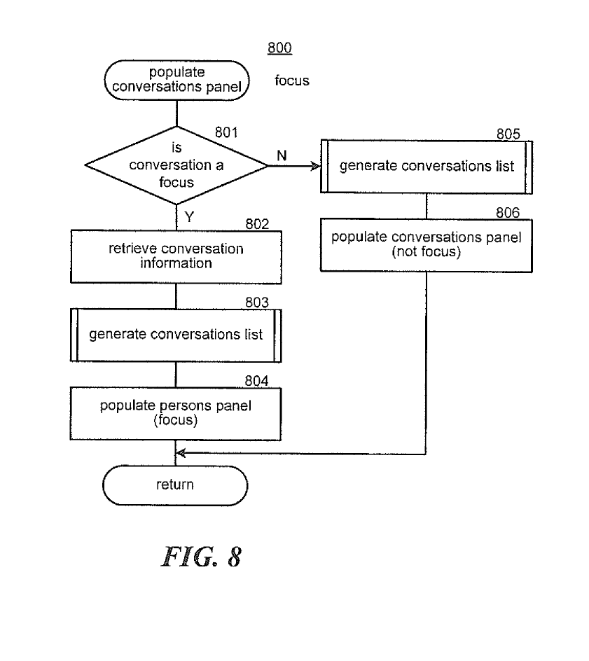

FIG. 8 is a flow diagram that illustrates the processing of a populate conversations panel component in some embodiments. The populate conversations panel component 800 populates a panel differently depending on whether the conversation is a focus of the relationship. In decision block 801, if a conversation is a focus of the relationship, then the component continues at block 802, else the component continues at block 805. In block 802, the component retrieves conversation information relating to the conversation that is the focus. In block 803, the component invokes a component to generate a list of conversations. In block 804, the component populates the conversations panel based on a conversation being a focus and then returns. In block 805, the component invokes the component to generate a list of conversations relating to the focus. In block 806, the component populates the conversations panel based on a conversation not being a focus and then returns.

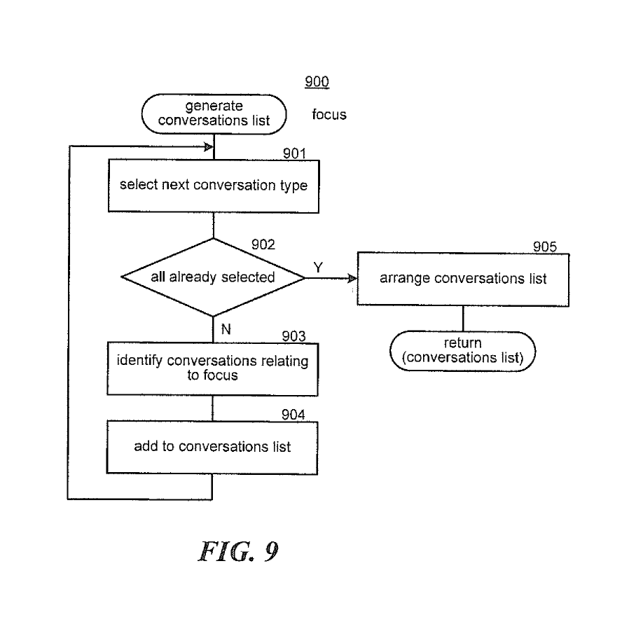

FIG. 9 is a flow diagram that illustrates the processing of a generate conversations list component in some embodiments. A generate conversations list component 900 is passed an indication of the focus and identifies conversations of different types that are related to the focus. In decision block 901, the component selects the next conversation type. In decision block 902, if all of the conversation types have already been selected, the component continues at block 905, else the component continues at block 903. In block 903, the component identifies the conversations of the selected conversation type that relate to the focus. In block 904, the component adds the identified conversations to the conversations list and then loops to block 901 to select the next conversation type. In block 905, the component arranges the conversations in an order, such as by time stamp of last message in a conversation, and then returns the conversations list.

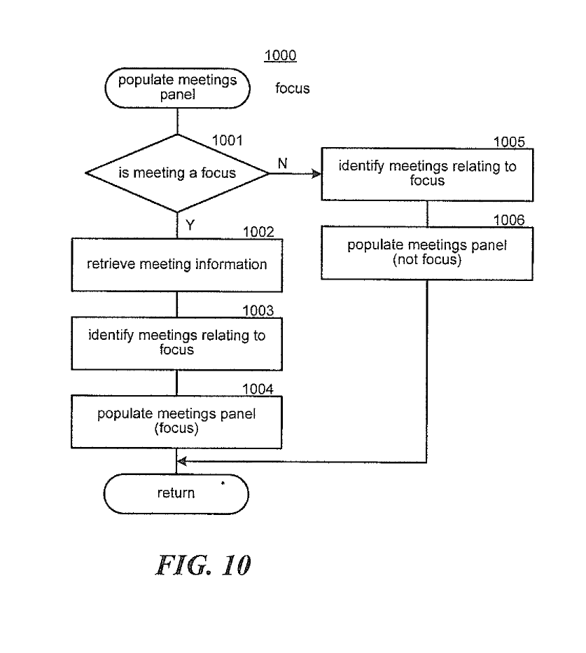

FIG. 10 is a flow diagram that illustrates the processing of a populate meetings panel component in some embodiments. The populate meetings panel component 1000 is passed an indication of the focus and populates the meetings panel differently depending on whether a meeting is the focus of the relationship. In decision block 1001, if a meeting is a focus of the relationship, then the component continues at block 1002, else the component continues at block 1005. In block 1002, the component retrieves information relating to the meeting that is the focus the relationship. In block 1003, the component identifies meetings that are related to the focus of the relationship. In block 1004, the component populates the meetings panel with the retrieved meeting information and any indications of the identified meetings and then returns. In block 1005, the component identifies meetings related to the focus. In block 1006, the component populates the meetings panel based on a meeting not being a focus of the relationship and then returns.

Although the subject matter has been described in language specific to structural features and/or acts, it is to be understood that the subject matter defined in the appended claims is not necessarily limited to the specific features or acts described above. Rather, the specific features and acts described above are disclosed as example forms that implement the claims. For example, the relationship view system may present the relationship information at various levels of detail depending on the context. For example, the relationship view system may initially list a summary of the relationship information such as the number of electronic mail messages, documents, and so on and then allow the user to select to see more detailed information such as a listing of each electronic mail message. Accordingly, the invention is not limited except as by the appended claims.

1. A computer-readable storage medium storing computer-executable instructions for controlling a computing device to generate a relationship view of information for a user, the computer-executable instructions comprising instructions that:
receive an indication of a focus for the relationship view, the focus being a collection entity of one or more members;
provide for display information relating to the collection entity; and
for each of a plurality of information types,
identify items of that information type that are related to both the user and the focus; and
provide for display information relating to the identified items of that information type
wherein information for multiple information types is provided for simultaneous display and wherein information provided for display is related to both the user and the focus.

2. The computer-readable storage medium of claim 1 wherein the instructions that identify items interface with an external system to identify items of at least one information type.

3. The computer-readable storage medium of claim 1 wherein an information type is selected from the group consisting of persons, conversations, meetings, and documents.

4. The computer-readable storage medium of claim 1 wherein the collection entity includes only one person.

5. The computer-readable storage medium of claim 1 wherein information types include conversations, meetings, and documents.

6. The computer-readable storage medium of claim 1 wherein the conversations are of different conversation types that are selected from a group consisting of electronic mail messages, instant messages, voice mails, and telephone calls.

7. The computer-readable storage medium of claim 1 including instructions that receive an indication of multiple focuses and wherein the identified items are related to the user and each of the multiple focuses.

8. The computer-readable storage medium of claim 1 wherein the information for each information type is provided for display in a separate panel.

9. The computer-readable storage medium of claim 1 including instructions for providing the information for display as a hover card.

10. The computer-readable storage medium of claim 9 wherein the provided information is to be displayed as a hover card when the received indication is based on hovering over an item.

11. The computer-readable storage medium of claim 9 wherein the information for display as a hover card is a condensed form of the identified information.

12. A method performed by a computing device to display a relationship view of information for a user, the method comprising:
receiving an indication of a person;
identifying electronic mail messages that include both the user and the person as participants;
identifying meetings for which both the person and the user are invited;
identifying documents to which both the person and the user have access; and
displaying, simultaneously on a display, contact information for that person and electronic mail message information relating to identified electronic mail messages, meeting information relating to identified meetings, and document information relating to identified documents.

13. The method of claim 12 wherein the electronic mail message information, the meeting information, and the document information are displayed in separate panels.

14. The method of claim 12 including in response to receiving an indication of a meeting, displaying simultaneously meeting information relating to that meeting, contact information of invitees to that meeting, and electronic mail message information for the electronic mail message that relates to the meeting and that includes the user as a participant.

15. The method of claim 12 including identifying additional items selected from the group of instant messages, voice mails, and telephone calls that include both the user and the person as participants and displaying information about the identified items simultaneously with the other displayed information.

16. A computing device for displaying a relationship view of information relating to a user and a person, the computing device comprising:
one or more computer-readable storage media storing computer-executable instructions that
display contact information about the person; and
for each of a plurality of information types,
identify items of that information type that relate to both the user and the person; and
display, simultaneously with the contact information, information relating to the identified items of that information type
so that the displayed information relating to the identified items relates to both the user and the person; and
a processor that executes the computer-executable instructions stored in the one or more computer-readable storage medium.

17. The computing device of claim 16 wherein an information type is selected from a group consisting of conversations, meetings, and documents.

18. The computing device of claim 16 wherein the information for the information types are displayed in separate panels.

19. The computing device of claim 16 wherein the instructions that identify the item of an information type are from an external system.

20. The computing device of claim 19 wherein the external system is a social networking system.
